(19) United States
(12) Patent Application Publication
(10) Pub. No.: US 2022/0161374 A1
(43) Pub. Date: May 26, 2022

(54) Method for Forming Lightweight Spacer

(71) Applicant: TOA DR ENTERPRISE CO., LTD., NEW TAIPEI CITY (TW)

(72) Inventors: Tao Chen CHOU, New Taipei City (TW); Tong Yong CHOU, New Taipei City (TW)

(21) Appl. No.: 17/534,553

(22) Filed: Nov. 24, 2021

(30) Foreign Application Priority Data
Nov. 26, 2020 (TW) 109141577

(51) Int. Cl. B23P 13/02; B26D 11/00; B23B 35/00; B24B 1/00

(52) U.S. Cl. CPC B23P 13/02; B26D 11/00; B26D 7/2635; B24B 1/00; B23B 35/00

(57) ABSTRACT

The present invention relates to a method for forming the spacer of slitting machine. Firstly, the material is provided, then various processing methods are applied to form the spacer with smooth surface and a plurality of fixed-distance columns. Compared to the conventional spacer, the weight of lightweight spacer of the invention is reduced by 50%±10%. Additionally, the lightweight spacer of the invention not only is placed on the other positions of slitting machine, but also is suitable for the machines of other relevant fields.

### BACKGROUND OF THE INVENTION

### 1. Field of the Invention

The present invention relates to a method for forming the lightweight spacer, more particularly to a method for forming the spacer of slitting machine.

### 2. Description of the Prior Art

Compared to the conventional slitting machine, or called slitter, which is consisted of several mechanical parts, such as the uncoiler, the slitter (lengthwise cutting) host device, the tension pad, and the recoiler etc. The main function of slitting machine is to slit the wide reeled material into several narrow strips. The slitting machine is suitable for cutting the metal-tape material lengthwise, and can reel the slit narrow strips again. Due to the slitting machine has the advantages of convenient operation, high cutting quality, high material utilization rate, and stepless cutting speed adjustment, the slitting machine is been widely applied by the industry at the present.

As the abovementioned description, the slitting machine is the machine which is used to slit the wide reeled material into several narrow strips, thus the materials which can be cut including the metal, the cloth, the paper, and the plastics etc. The form of wide material is usually reel shape, such as thin steel reel. The wide material is usually placed on the material feeder, or called reel discharging machine or uncoiler, for de-reeling. After the material is cut by the slitting knife, then sending to the material acceptor for reeling into narrow strips.

The slitting machine comprises the slitting knife, usually, the slitting knife is round ring shape and set on the knife arbor. According to the cutting requirements, several slitting knives is set at the same time and the cutting width is adjusted. As for the method of adjusting the cutting width of slitting machine, is to set the spacer (including separator, knives spacer, slitter spacer, shim, and disc) complied with the cutting width on the knife arbor, so that the slitting knives can be fixed in the set cutting width.

The materials adopted for the slitting knife of slitting machine comprise the tool steel, high-speed steel, and tungsten steel, the above materials are suitable for various metals, nonferrous metals, and rare metal reel materials, particularly suitable for carrying on high-speed cutting operation.

In the application of conventional slitting machine, when the field technician operates the slitting machine, if it is necessary to adjust the cutting width, a large amount of time and physical power have to be spent to carry on the adjustment of whole machine, which even will influence the processing time of slitting machine, that will also reduce the production efficiency of slitting machine, thus it needs suitable auxiliary apparatus or spacer, in order to reduce the unnecessary adjustment time of slitting machine, and keep better production efficiency.

In order to solve the abovementioned problem, the main purpose of the present invention is to provide a method for forming the lightweight spacer. Firstly, the metal material and nonmetal material are provided. Continuously, the metal material and nonmetal material are cut into the block-shaped body. Then, various processing methods are used to process the block-shaped body into the cylinder. Consequently, the holes are drilled and put a plurality of fixed-distance columns into the cylinder to form the cylinder with a plurality of fixed-distance columns. Finally, the cylinder with a plurality of fixed-distance columns is ground to form the spacer with smooth surface and a plurality of fixed-distance columns.

As for one of the advantages of the present invention, compared to the conventional spacer, the weight of lightweight spacer of the present invention can be reduced by 50%+10%. Therefore, the present invention can also be called as a method for forming the lightweight knife set.

As for one of the advantages of the present invention, the lightweight spacer of the present invention can possess none key-groove, rectangular key-groove, and semicircular key-groove etc.

The present invention possess the convenience of utilization. The lightweight spacer of the present invention can be placed to the center of slitting knives of slitting machine, that is to be placed between the slitting knives. The slitting knives can be cooperated with the spacer, namely the spacer, to adjust the required cutting size, in order to adjust the interval of every knife set to control the width of material to be processed.

The lightweight spacer of the present invention not only can be placed on the other positions of slitting machine, but also can be suitable for the machines of other relevant fields. The multiple use of the present invention makes a great deal of convenience for the use of the present invention.

From the following description, it can further understand the features and advantages of the present invention. Please refer to the attached Figures upon reading.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is the flow diagram schematically illustrating the embodiment of the present invention;

FIG. 2A is the front view of spacer without key groove;

FIG. 2B is the three dimensional view of spacer without key groove;

FIG. 3A is the front view of spacer with rectangular key groove;

FIG. 3B is the three dimensional view of spacer with rectangular key groove;

FIG. 4A is the front view of spacer with semicircular key groove; and

FIG. 4B is the three dimensional view of spacer with semicircular key groove.

### DESCRIPTION OF THE PREFERRED EMBODIMENT

The attached figures should be used to describe the implement way of the present invention. In the figures, the same element symbol is used to represent the same element. In order to describe the element more clearly, its size or thickness might be scaled.

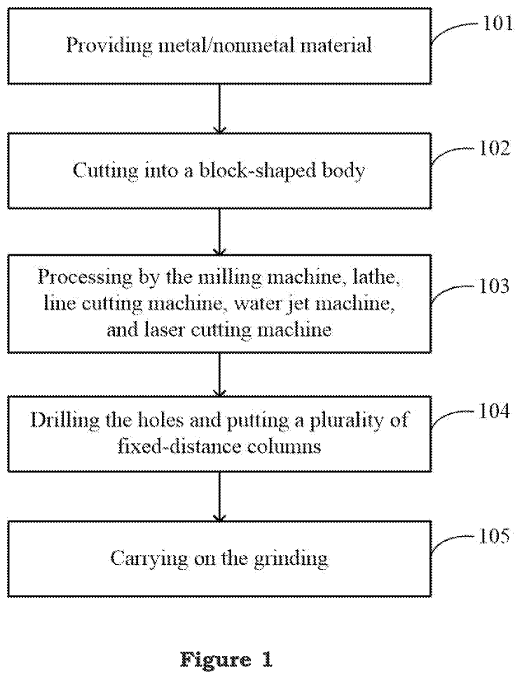

As shown in FIG. 1, the present invention provides the flow diagram of a method for forming the spacer, or provides the flow diagram of a method for forming the lightweight spacer, or provides the flow diagram of a method for forming the spacer of slitting machine, or particularly provides the flow diagram of a method for forming the lightweight spacer of slitting machine.

As the abovementioned description, the spacer can also be called as the “separator”, “knives spacer”, “slitter spacer”, “shim”, “disc”, “fixed-distance spacer”, and “stripper ring” etc.

Please refer to Step 101 of FIG. 1. Firstly, the metal material and nonmetal material are provided, wherein the nonmetal material comprises the plastic material, and the plastic material comprises the block-shaped plastic material or bar-shaped plastic material.

As shown in Step 102 of FIG. 1, consequently, the metal material and nonmetal material are cut into the block-shaped metal body. The cutting method is to divide the physical subject into two or a plurality of parts through applying a sharp direction force. The cutting machines used in the present invention comprise but not limited to the following devices: sawing machine, milling machine (CNC), laser cutting machine, water jet cutting machine, line cutting machine, lathe, slotting machine, and broaching machine etc.

Then as shown in Step 103 of FIG. 1, the milling machine, lathe, water jet machine, and line cutting machine are used to process the block-shaped body into cylinder. Wherein, in the present invention, the processing can be conducted through the signal driven. In the processing, the block-shaped body carries on the plane movement in the direction of X axis and Y axle, while the Z axle is the main rotation shaft of the cutter, in order to obtain the cylinder.

Again, as shown in Step 104 of FIG. 1, consequently, using the drill method to drill the cylinder, at this time, a plurality of fixed-distance column holes are produced into the cylinder, and then put a plurality of fixed-distance columns into the cylinder, to form the cylinder having a plurality of fixed-distance columns. Another, the drilling method used in the present invention is to use the drill bit to drill the holes with large circular cross-section into the above cylinder, in order to form the fixed-distance column holes after above processing, wherein, the drill bit is the rotating-type cutting tool, most likely there are a plurality of cutting edge. Upon carrying on the boring procedure, the drill bit will be pressed to close the cylinder. The rotation speed of drill bit is from several hundred rotations per minute (RPM) to several thousand rotations per minute. When the drill bit penetrates through the cylinder by the pressure and rotation speed, a plurality of holes will be left, and the debris will be peeled from the holes of cylinder.

Consequently, as shown in Step 105 of FIG. 1, the cylinder with a plurality of fixed-distance columns is ground to form the knife set with smooth surface and a plurality of fixed-distance columns. In the present invention, the grinding machine is used to carry on the precision processing, the abrasive particles are coated or inlaid on the grinding machine to grind the work piece to form the lightweight knife set with smooth surface. Another, the relative motion is carried on under the certain pressure for carrying on the precision processing on the surface. In the present invention, the abrasive particles and the additive can also be mixed and dispersed in the solvent, in order to obtain high smooth finish through the relative motion with the processing surface.

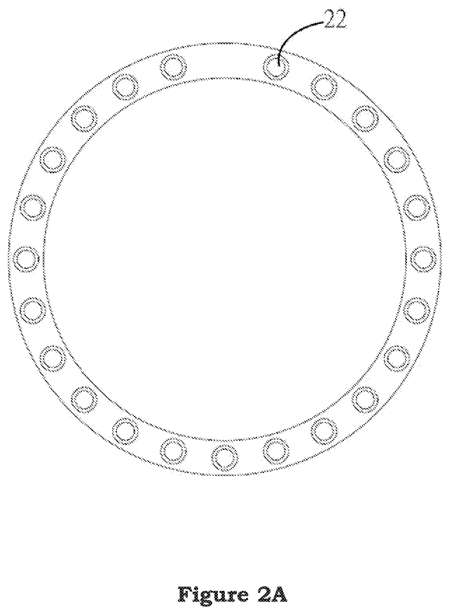

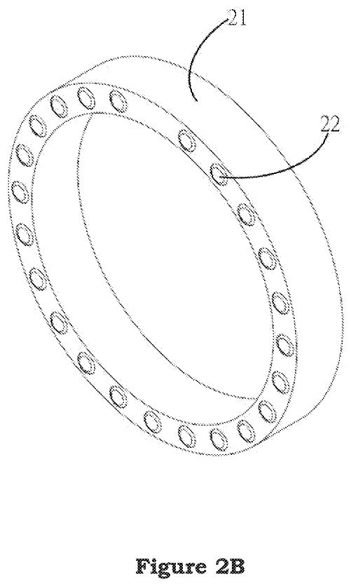

As the spacer shown in the embodiment of the present invention, FIG. 2A is the front view of spacer having none-key groove, and FIG. 2B is the three dimensional view of spacer having none-key groove, wherein the main body 21 and the fixed-distance column 22 are comprised.

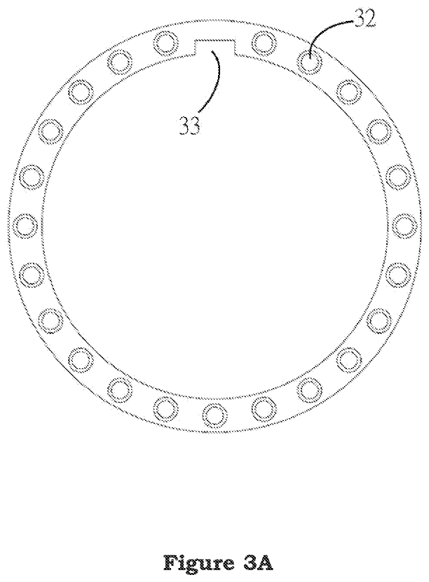

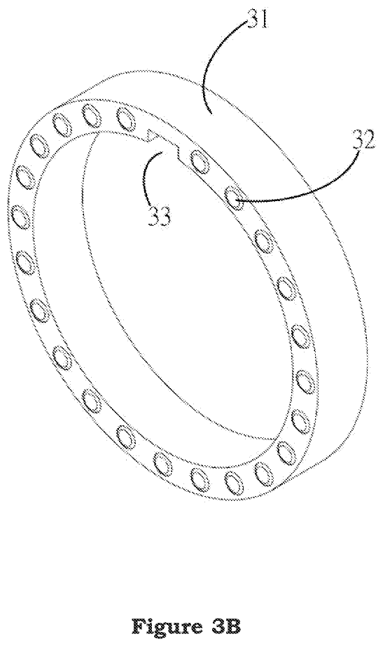

As the spacer shown in the embodiment of the present invention, FIG. 3A is the front view of spacer having rectangular-key groove, and FIG. 3B is the three dimensional view of spacer having rectangular-key groove, wherein the main body 31, the fixed-distance column 32, and the rectangular-key groove 33 are comprised.

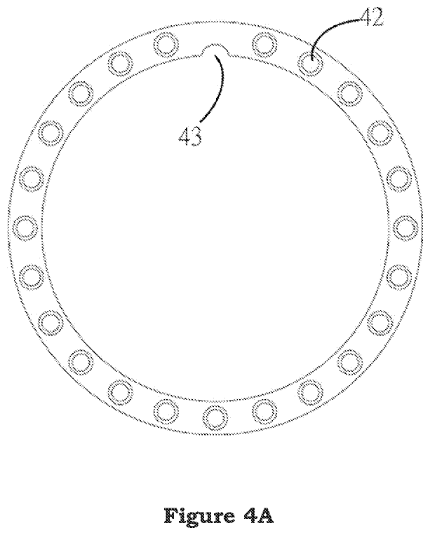

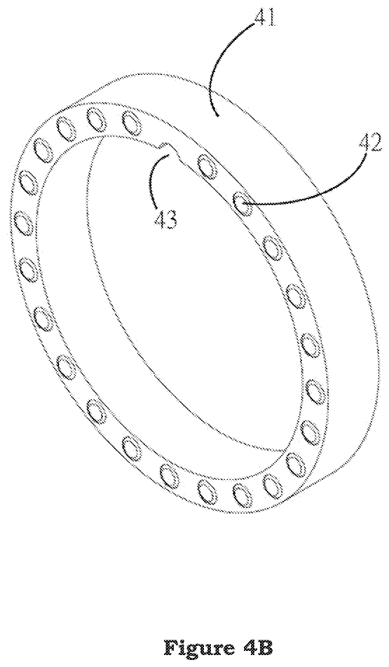

As the spacer shown in the embodiment of the present invention, FIG. 4A is the front view of spacer having semicircular-key groove, and FIG. 4B is the three dimensional view of spacer having semicircular-key groove, wherein the main body 41, the fixed-distance column 42, and the semicircular-key groove 43 are comprised.

In addition, as for the plastics processing, the plastics may be adopted for the spacer of the present invention. Firstly, the powder material of plastics can be adopted. Then, the plastics injection molding is carried on. After the cylinder with a plurality of fixed-distance column is formed, then it is ground to form the lightweight spacer with smooth surface finally.

As for the lightweight spacer of the present invention, it can possess none-key groove, rectangular-key groove, and semicircular-key groove etc. As for the use of various key grooves (including none-key groove, rectangular-key groove, and semicircular-key groove), it can prevent the relative rotation between the slitting knife and arbor, or the spacer and arbor, in order to transmit the power.

Compared to the conventional spacer, the weight of lightweight spacer of the present invention can be reduced by 50%±10%. Thus the present invention can also be called as a method for forming the lightweight spacer. The present invention possess the convenience of utilization. The lightweight spacer of the present invention can be placed to the center of slitting (lengthwise cutting) knives of slitting machine (slitter), that is to be placed between the slitting knives. The slitting knives can be cooperated with the spacer, to adjust the required cutting size, in order to adjust the interval of every spacer to control the width of material to be processed. The lightweight spacer of the present invention not only can be placed on the other positions of slitting machine, but also can be suitable for the machines of other relevant fields. The multiple use of the present invention makes a great deal of convenience for the use of the present invention.

It is understood that various modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to witch this invention pertains.

What is claimed is:

1. A method for forming a lightweight spacer, comprising:
providing a metal material;
cutting said metal material into a block-shaped body by a cutting method, wherein said cutting machine used in said cutting method is selected from the group consisting of a sawing machine, a broaching machine, a slotting machine, a laser cutting machine, a water jet cutting machine, a line cutting machine, and a lathe;
cutting said block-shaped body into a cylinder-shaped body by said cutting method, wherein said cutting machine used in said cutting method is selected from the group consisting of a milling machine, a lathe, a water jet cutting machine, and a line cutting machine;
drilling said cylinder-shaped body by a drilling method to form a cylinder-shaped body having a plurality of fixed-distance column holes for putting a plurality of fixed-distance columns, said drilling method being to use a drill bit to drill said cylinder-shaped body, processing said drilling method in order to enlarge every circular cross-section of said plurality of fixed-distance column holes, and in order to form said plurality of fixed-distance column holes, wherein said drill bit being a rotating-type cutting tool having a plurality of cutting edge; and
grinding said cylinder-shaped body having said plurality of fixed-distance column holes to form a knife set having a smooth surface and said plurality of fixed-distance columns, and said spacer having a key groove, wherein said key groove is selected from the group consisting of a none-key groove, a rectangular-key groove, and a semicircular-key groove.

2. A method for forming a lightweight spacer, comprising:
providing a plastic material;
cutting said plastic material into a block-shaped body by a cutting method, wherein said cutting machine used in said cutting method is selected from the group consisting of a sawing machine, a broaching machine, a slotting machine, a laser cutting machine, a water jet cutting machine, a line cutting machine, and a lathe;
cutting said block-shaped body into a cylinder-shaped body by said cutting method, wherein said cutting machine used in said cutting method is selected from the group consisting of a milling machine, a lathe, a water jet cutting machine, and a line cutting machine;
drilling said cylinder-shaped body by a drilling method to form a cylinder-shaped body having a plurality of fixed-distance column holes for putting a plurality of fixed-distance columns, said drilling method being to use a drill bit to drill said cylinder-shaped body, processing said drilling method in order to enlarge every circular cross-section of said plurality of fixed-distance column holes, and in order to form said a plurality of fixed-distance column holes, wherein said drill bit being a rotating-type cutting tool having a plurality of cutting edge; and
grinding said cylinder-shaped body having said plurality of fixed-distance column holes to form a knife set with a smooth surface and said plurality of fixed-distance columns, and the spacer having a key groove, wherein said key groove is selected from the group consisting of a none key groove, a rectangular key groove, and a semicircular key groove.

3. The method according to claim 2, wherein said plastic material is selected from the group consisting of block-shaped plastic material and a bar-shaped plastic material.
